(19) United States
(12) Patent Application Publication
(10) Pub. No.: US 2016/0098804 A1
(43) Pub. Date: Apr. 7, 2016

(54) METHOD AND SYSTEM FOR USING INTERCHANGEABLE ANALYTICS MODULES TO PROVIDE TAX RETURN PREPARATION SYSTEMS

(71) Applicant: INTUIT INC., Mountain View, CA (US)

(72) Inventors: Massimo Mascaro, San Diego, CA (US); Jonathan R. Goldman, Mountain View, CA (US); William T. Laaser, Palo Alto, CA (US)

(73) Assignee: INTUIT INC., Mountain View, CA (US)

(21) Appl. No.: 14/508,861

(22) Filed: Oct. 7, 2014

(51) Int. Cl. G06Q 40/00

(52) U.S. Cl. CPC G06Q 40/123

(57) ABSTRACT

A method and system for providing a tax return preparation system with interchangeable analytics modules includes providing one or more interchangeable analytics modules. Each of the interchangeable analytics modules includes one or more analytics algorithms used to select user experience elements to be included in a tax return preparation interview process presented to a user through one or more tax return preparation systems. The one or more interchangeable analytics modules are distinct and independent analytical components provided to the tax return preparation system that can be interchanged, overwritten, and interfaced with individually, and without otherwise changing and/or modifying the tax return preparation system. Consequently, a tax return preparation system can provide a tax return preparation interview process capable of dynamically evolving to meet the specific needs of a given user.

### BACKGROUND

Federal and State Tax law has become so complex that it is now estimated that each year Americans alone use over 6 billion person hours, and spend nearly 4 billion dollars, in an effort to comply with Federal and State Tax statutes. Given this level of complexity and cost, it is not surprising that more and more taxpayers find it necessary to obtain help, in one form or another, to prepare their taxes. Tax return preparation systems, such as tax return preparation software programs and applications, represent a potentially flexible, highly accessible, and affordable source of tax preparation assistance. However, traditional tax return preparation systems are, by design, fairly generic in nature and often lack the malleability to meet the specific needs of a given user.

For instance, traditional tax return preparation systems often present a fixed, e.g., predetermined and pre-packaged, structure or sequence of questions to all users as part of the tax return preparation interview process. Likewise, traditional tax return preparation systems often provide other user experiences associated with the tax return preparation systems, such as, but not limited to, interfaces, images, and assistance resources, in a static and generic manner to every user. This is largely due to the fact that the traditional tax return preparation system analytics used to generate a sequence of interview questions, and/or other user experiences, are static features that are typically hard-coded elements of the tax return preparation system and do not lend themselves to effective or efficient modification. As a result, the user experience, and any analysis associated with the interview process and user experience, is a largely inflexible component of a given version of the tax return preparation system. Consequently, the interview processes and/or the user experience of traditional tax return preparation systems can only be modified through a redeployment of the tax return preparation system itself. Therefore, there is little or no opportunity for any analytics associated with interview process, and/or user experience, to evolve to meet a changing situation or the particular needs of a given taxpayer, even as more information about that taxpayer, and their particular circumstances, is obtained.

As an example, using traditional tax return preparation systems, the sequence of questions, and the other user experience elements, presented to a user is pre-determined based on a generic user model that is, in fact and by design, not accurately representative of any “real world” user. Consequently, irrelevant, and often confusing, interview questions are virtually always presented to any given real world user. It is therefore not surprising that many users, if not all users, of these traditional tax return preparation systems experience, at best, an impersonal, unnecessarily long, confusing, and complicated, interview process and user experience. Clearly, this is not the type of impression that results in happy, loyal, repeat customers.

Even worse is the fact that, in many cases, the hard-coded and static analysis features associated with traditional tax return preparation systems, and the resulting presentation of irrelevant questioning and user experiences, leads potential users of traditional tax return preparation systems, i.e., potential customers, to believe that the tax return preparation system is not applicable to them, and perhaps is unable to meet their specific needs. In other cases, the users simply become frustrated with these irrelevant lines of questioning and other user experience elements. Many of these potential users and customers then simply abandon the process and the tax return preparation systems completely, i.e., never become paying customers. Clearly, this is an undesirable result for both the potential user of the tax return preparation system and the provider of the tax return preparation system.

What is needed is a method and system for providing a tax return preparation system with an analysis capability that can be dynamically and independently modified and/or evolved to individualize the interview process and user experience provided through a tax return preparation system.

### SUMMARY

Embodiments of the present disclosure address some of the shortcomings associated with traditional tax return preparation systems by providing “pluggable,” e.g., interchangeable analytics modules to one or more tax return preparation systems that can be selected, interfaced with, and interchanged, without requiring the redeployment of either the tax return preparation systems or any individual analytics module. In this way, different types of analysis and processes can be utilized by a single tax return preparation system or version, or multiple tax return preparation systems and versions, to provide individualized user experiences, including, but not limited to, individualized: user interview questions and question sequences, user interfaces, images, user recommendations, and supplemental actions and recommendations.

In one embodiment, using the interchangeable analytics modules described herein, the tax return preparation interview process and user experience can be evolved based on provided user data to improve and customize the user experience associated with the tax return preparation system. According to one embodiment, by improving the user experience using the interchangeable analytics modules described herein, the tax return preparation interview and user experience feels more personal to the user, may be shorter in duration, and may reduce the amount of irrelevant or less-relevant information that is presented to the user.

According to one embodiment, by employing the interchangeable analytics modules described herein, the tax return preparation interview process and user experience is individualized by presenting tax return interview questions in an order of relevancy to the user, based on the user's data and an analytics algorithm provided through a selected one of the one or more interchangeable analytics modules. According to one embodiment, the order of relevancy begins with questions determined by the selected one of the one or more interchangeable analytics modules to have a high-level, or a threshold level, of relevancy and ending with, or omitting, questions having a low-level of relevancy. As noted above, in one embodiment, question relevancy is determined by a selected one of the one or more of the interchangeable analytics modules described herein based on user data such as, but not limited to: a name, an address, a birth date, a government identification, a marital status, a home ownership status, a number of children, ages of the number of children, a job title, an annual income, an employment status, a previous tax return, a level of completed education, and/or various other user data similar to the specific illustrative user data examples discussed herein.

According to one embodiment, other user experience features such as, but not limited to, interfaces, images, assistance resources, backgrounds, avatars, highlighting mechanisms, icons, and any other features that individually, or in combination, create a user experience, as discussed herein, and/or as known in the art at the time of filing, and/or as developed after the time of filing are altered, adjusted, and/or customized to the user, based on the user's data and a selected one of the one or more of the interchangeable analytics modules described herein.

As noted above, in one embodiment, individualizing the tax return preparation interview process is accomplished, at least in part, by providing the user data associated with a given user to one or more of the interchangeable analytics modules described herein. In one embodiment, the selected one of the interchangeable analytics modules then processes the user data according to the specific analytics algorithm included in the selected interchangeable analytics module to generate, specify, and/or determine which question sequence or user experience features are to be provided to the user. According to one embodiment, instead of modifying an entire tax return preparation system application, improvements to algorithms for individualizing the tax return preparation interview process, or other user experience features, may be updated simply by replacing or overwriting a prior version of one or more interchangeable analytics modules with an updated version of the interchangeable analytics modules, potentially saving significant time and development costs, and providing a “plug and play,” real time/minimal down time modification capability.

Therefore, the various embodiments of the disclosure, and their associated benefits, as discussed herein, improve the technical field of tax return preparation by providing an interchangeable analytics module architecture that provides an evolving, dynamic, and customized tax return preparation user experience. In addition, by individualizing/personalizing the tax return preparation interview and user experience, tax return preparation applications using the interchangeable analytics module architecture discussed herein are able to efficiently gather more complete information from the user and provide a more thorough and customized analysis of potential tax return benefits for the user.

### BRIEF DESCRIPTION OF THE DRAWINGS

FIG. 1 is a block diagram of software architecture for providing a tax return preparation system with interchangeable analytics modules in accordance with one embodiment.

FIG. 2 is a block diagram of a process for providing a tax return preparation system with interchangeable analytics modules in accordance with one embodiment.

FIG. 3 is a flow diagram for individualizing a computerized tax return preparation interview using a tax return preparation system with interchangeable analytics modules in accordance with one embodiment.

Common reference numerals are used throughout the FIG.s and the detailed description to indicate like elements. One skilled in the art will readily recognize that the above FIG.s are examples and that other architectures, modes of operation, orders of operation, and elements/functions can be provided and implemented without departing from the characteristics and features of the invention, as set forth in the claims.

### DETAILED DESCRIPTION

Embodiments will now be discussed with reference to the accompanying FIG.s, which depict one or more exemplary embodiments. Embodiments may be implemented in many different forms and should not be construed as limited to the embodiments set forth herein, shown in the FIG.s, and/or described below. Rather, these exemplary embodiments are provided to allow a complete disclosure that conveys the principles of the invention, as set forth in the claims, to those of skill in the art.

The INTRODUCTORY SYSTEM, HARDWARE ARCHITECTURE, and PROCESS sections herein describe systems and processes suitable for providing a tax return preparation system with interchangeable analytics modules according to various embodiments.

### Introductory System

Herein, the term “production environment” includes the various components, or assets, used to deploy, implement, access, and use, a given application as that application is intended to be used. In various embodiments, production environments include multiple assets that are combined, communicatively coupled, virtually and/or physically connected, and/or associated with one another, to provide the production environment implementing the application.

As specific illustrative examples, the assets making up a given production environment can include, but are not limited to, one or more computing environments used to implement the application in the production environment such as a data center, a cloud computing environment, a dedicated hosting environment, and/or one or more other computing environments in which one or more assets used by the application in the production environment are implemented; one or more computing systems or computing entities used to implement the application in the production environment; one or more virtual assets used to implement the application in the production environment; one or more supervisory or control systems, such as hypervisors, or other monitoring and management systems, used to monitor and control assets and/or components of the production environment; one or more communications channels for sending and receiving data used to implement the application in the production environment; one or more access control systems for limiting access to various components of the production environment, such as firewalls and gateways; one or more traffic and/or routing systems used to direct, control, and/or buffer, data traffic to components of the production environment, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement the application in the production environment; one or more databases used to store data in the production environment; one or more internal or external services used to implement the application in the production environment; one or more backend systems, such as backend servers or other hardware used to process data and implement the application in the production environment; one or more software systems used to implement the application in the production environment; and/or any other assets/components making up an actual production environment in which an application is deployed, implemented, accessed, and run, e.g., operated, as discussed herein, and/or as known in the art at the time of filing, and/or as developed after the time of filing.

As used herein, the terms “computing system,” “computing device,” and “computing entity,” include, but are not limited to, a virtual asset; a server computing system; a workstation; a desktop computing system; a mobile computing system, including, but not limited to, smart phones, portable devices, and/or devices worn or carried by a user; a database system or storage cluster; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

In addition, as used herein, the terms “computing system” and “computing entity,” can denote, but are not limited to, systems made up of multiple: virtual assets; server computing systems; workstations; desktop computing systems; mobile computing systems; database systems or storage clusters; switching systems; routers; hardware systems; communications systems; proxy systems; gateway systems; firewall systems; load balancing systems; or any devices that can be used to perform the processes and/or operations as described herein.

As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known environments, e.g., “trusted” environments, or unknown, e.g., “untrusted” environments. Typically, trusted computing environments are those where the assets, infrastructure, communication and networking systems, and security systems associated with the computing systems and/or virtual assets making up the trusted computing environment, are either under the control of, or known to, a party.

In various embodiments, each computing environment includes allocated assets and virtual assets associated with, and controlled or used to create, and/or deploy, and/or operate an application.

In various embodiments, one or more cloud computing environments are used to create, and/or deploy, and/or operate an application that can be any form of cloud computing environment, such as, but not limited to, a public cloud; a private cloud; a virtual private network (VPN); a subnet; a Virtual Private Cloud (VPC); a sub-net or any security/communications grouping; or any other cloud-based infrastructure, sub-structure, or architecture, as discussed herein, and/or as known in the art at the time of filing, and/or as developed after the time of filing.

In many cases, a given application or service may utilize, and interface with, multiple cloud computing environments, such as multiple VPCs, in the course of being created, and/or deployed, and/or operated.

As used herein, the term “virtual asset” includes any virtualized entity or resource, and/or virtualized part of an actual, or “bare metal” entity. In various embodiments, the virtual assets can be, but are not limited to, virtual machines, virtual servers, and instances implemented in a cloud computing environment; databases associated with a cloud computing environment, and/or implemented in a cloud computing environment; services associated with, and/or delivered through, a cloud computing environment; communications systems used with, part of, or provided through, a cloud computing environment; and/or any other virtualized assets and/or sub-systems of “bare metal” physical devices such as mobile devices, remote sensors, laptops, desktops, point-of-sale devices, etc., located within a data center, within a cloud computing environment, and/or any other physical or logical location, as discussed herein, and/or as known/available in the art at the time of filing, and/or as developed/made available after the time of filing.

In various embodiments, any, or all, of the assets making up a given production environment discussed herein, and/or as known in the art at the time of filing, and/or as developed after the time of filing, can be implemented as one or more virtual assets.

In one embodiment, two or more assets, such as computing systems and/or virtual assets, and/or two or more computing environments, are connected by one or more communications channels including but not limited to, Secure Sockets Layer (SSL) communications channels and various other secure communications channels, and/or distributed computing system networks, such as, but not limited to: a public cloud; a private cloud; a virtual private network (VPN); a subnet; any general network, communications network, or general network/communications network system; a combination of different network types; a public network; a private network; a satellite network; a cable network; or any other network capable of allowing communication between two or more assets, computing systems, and/or virtual assets, as discussed herein, and/or available or known at the time of filing, and/or as developed after the time of filing.

As used herein, the term “network” includes, but is not limited to, any network or network system such as, but not limited to, a peer-to-peer network, a hybrid peer-to-peer network, a Local Area Network (LAN), a Wide Area Network (WAN), a public network, such as the Internet, a private network, a cellular network, any general network, communications network, or general network/communications network system; a wireless network; a wired network; a wireless and wired combination network; a satellite network; a cable network; any combination of different network types; or any other system capable of allowing communication between two or more assets, virtual assets, and/or computing systems, whether available or known at the time of filing or as later developed.

As used herein, the term “user” includes, but is not limited to, any party, parties, entity, and/or entities using, or otherwise interacting with any of the methods or systems discussed herein. For instance, in various embodiments, a user can be, but is not limited to, a person, a commercial entity, an application, a service, and/or a computing system.

As used herein, the terms “interview” and “interview process” include, but are not limited to, an electronic, software-based, and/or automated delivery of multiple questions to a user and an electronic, software-based, and/or automated receipt of responses from the user to the questions, to progress a user through one or more groups or topics of questions, according to various embodiments.

As used herein, the term “user experience” includes not only the interview process, interview process questioning, and interview process questioning sequence, but also other user experience features provided or displayed to the user such as, but not limited to, interfaces, images, assistance resources, backgrounds, avatars, highlighting mechanisms, icons, and any other features that individually, or in combination, create a user experience, as discussed herein, and/or as known in the art at the time of filing, and/or as developed after the time of filing.

### Hardware Architecture

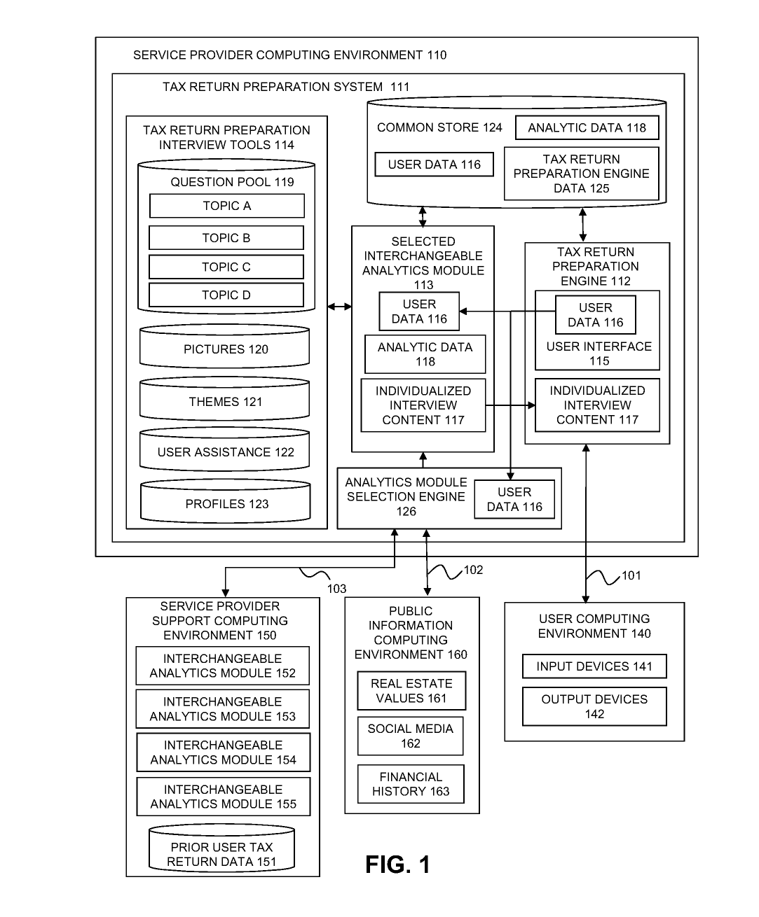

FIG. 1 illustrates a block diagram of a production environment 100 for providing a tax return preparation system with interchangeable analytics modules, according to one embodiment. The production environment 100 provides a tax return preparation system with interchangeable analytics modules by receiving user data from a user, running the user data through a selected interchangeable analytics module of one or more interchangeable analytics modules, receiving individualized interview content that is based on the user data from the selected interchangeable analytics module, and presenting the individualized interview content to the user, according to one embodiment. The selected interchangeable analytics module is an interchangeable or pluggable component within the production environment 100 and enables the production environment 100 to be executed with different algorithms or analysis routines by overwriting/replacing one interchangeable analytics module with another, according to one embodiment. The function and plug-ability of the interchangeable analytics module enables the production environment 100 to customize/individualize a user's tax return preparation interview and to update the individualization algorithms without altering other parts of the production environment 100, e.g., the tax return preparation interview software application itself, according to one embodiment.

As discussed above, there are various long standing shortcomings associated with traditional tax return preparation systems. Because traditional programs incorporate hard-coded analytics algorithms and fixed sequences of questions, user interfaces, and other elements of the user experience, traditional tax return preparation systems provide a user experience that is impersonal and that has historically been a source of confusion and frustration to a user. Using traditional tax return preparation systems, users who are confused and frustrated by irrelevant questioning, and other generic user experience features, often attempt to terminate the interview process as quickly as possible, and/or provide, unwittingly, incorrect or incomplete data. As a result, traditional tax return preparation programs may fail to generate an optimum benefit to the user, e.g., the benefit the user would be provided if the user were interviewed with more pertinent questions, in a more logical order for that user, and using customized user experience elements.

As one illustrative example, a single-mother that is high-school educated and who makes less than $20,000 a year is more likely to be confused by questions related to interest income, dividend income, or other investment related questions than her counterpart who is a business executive making a six-figure income. Traditionally, a professional tax return specialist was needed to adjust the nature of questions used in an interview based on initial information received from a user. However, professional tax return specialists are expensive and less accessible than an electronic tax return preparation system, e.g., a professional tax return specialist may have hours or operate in locations that are inconvenient to some taxpayers who have inflexible work schedules.

Inefficiencies associated with updating traditional tax return preparation systems is an additional long-standing shortcoming. Even if potential improvements to traditional tax return preparation systems become available, the costs associated with developing, testing, releasing, and debugging a new version of the tax return preparation system each time a new or improved analytic algorithm is discovered, or defined, will often outweigh the benefits gained by a user, or even a significant sub-set of users.

The production environment 100 addresses some of the shortcomings associated with traditional tax return preparation systems by utilizing one or more interchangeable analytics modules to individualize the tax return preparation interview process based on user data and to improve the user experience associated with the tax return preparation interview, according to one embodiment. The production environment 100 further addresses some of the shortcomings associated with traditional tax return preparation systems by providing interchangeable analytics modules that can be updated, overwritten, or otherwise modified without changing other aspects of the disclosed tax return preparation system. As a result, embodiments of the present disclosure improve the technical fields of user experience, electronic tax return preparation, and data flow and distribution by enabling a tax return preparation system to gather more complete information from the user and to provide a more thorough and customized analysis of potential tax return benefits for the user.

In addition, by minimizing, or potentially eliminating, the processing and presentation of irrelevant questions and other user experience features, implementation of embodiments of the present disclosure allows for significant improvement to the field of data collection and data processing. As one illustrative example, by minimizing, or potentially eliminating, the processing and presentation of irrelevant question data to a user, implementation of embodiments of the present disclosure allows for relevant data collection using fewer processing cycles and less communications bandwidth. As a result, embodiments of the present disclosure allow for improved processor performance, more efficient use of memory access and data storage capabilities, reduced communication channel bandwidth utilization, and faster communications connections. Consequently, computing and communication systems implementing and/or providing the embodiments of the present disclosure are transformed into faster and more operationally efficient devices and systems.

The production environment 100 includes a service provider computing environment 110, a user computing environment 140, a service provider support computing environment 150, and a public information computing environment 160 for individualizing a tax return preparation interview for a user, according to one embodiment. The computing environments 110, 140, 150, and 160 are communicatively coupled to each other with a communication channel 101, a communication channel 102, and a communication channel 103, according to one embodiment.

The service provider computing environment 110 represents one or more computing systems such as, but not limited to, a server, a computing cabinet, and/or distribution center that is configured to receive, execute, and host one or more tax return preparation applications for access by one or more users, e.g., clients of the service provider, according to one embodiment. The service provider computing environment 110 includes a tax return preparation system 111 utilizing interchangeable analytics modules for individualizing a tax return preparation interview and user experience, according to one embodiment. The tax return preparation system 111 includes various components, databases, engines, modules, and data to support the execution of interchangeable analytics modules that facilitate the individualization of the tax return preparation interview process, according to one embodiment. The tax return preparation system 111 includes a tax return preparation engine 112, a selected interchangeable analytics module 113, and tax return preparation interview tools 114, according to one embodiment.

The tax return preparation engine 112 guides the user through the tax return preparation process by presenting the user with interview content, such as interview questions and other user experience features, and by receiving user data from the user, according to one embodiment. The tax return preparation engine 112 includes a user interface 115 to receive user data 116 from the user and to present individualized interview and user experience content 117 to the user, according to one embodiment. The user interface 115 includes one or more user experience elements and graphical user interface tools, such as, but not limited to, buttons, slides, dialog boxes, text boxes, drop-down menus, banners, tabs, directory trees, links, audio content, video content, and/or other multimedia content for communicating information to the user and for receiving the user data 116 from the user, according to one embodiment. The tax return preparation engine 112 employs the user interface 115 to receive the user data 116 from input devices 141 of the user computing environment 140 and employs the user interface 115 to transmit the individualized interview content 117 (inclusive of various user experience elements) to output devices 142 of the user computing environment 140, according to one embodiment.

The user data 116 can include, but is not limited to, a user's name, a Social Security number, government identification, a driver's license number, a date of birth, an address, a zip code, a home ownership status, a marital status, an annual income, a job title, an employer's address, spousal information, children's information, assets, medical history, and the like, according to various embodiments. In some implementations, the user data 116 is a subset of all of the user information used by the tax return preparation system 111 to prepare the user's tax return, e.g., is limited to marital status, children's information, and annual income.

The individualized interview content 117 is received from the selected interchangeable analytics module 113 after the selected interchangeable analytics module 113 analyzes the user data 116, according to one embodiment. The individualized interview content 117 can include, but is not limited to, a sequence with which interview questions are presented, the content/topics of the interview questions that are presented, the font sizes used while presenting information to the user, the length of descriptions provided to the user, themes presented during the interview process, the types of icons displayed to the user, the type of interface format presented to the user, images displayed to the user, assistance resources listed and/or recommended to the user, backgrounds presented, avatars presented to the user, highlighting mechanisms used and highlighted features, and any other features that individually, or in combination, create a user experience, as discussed herein, and/or as known in the art at the time of filing, and/or as developed after the time of filing, that are displayed in, or as part of, the user interface 115 to acquire information from the user, the length of descriptions provided to the user, themes presented during the interview process, and/or the type of user assistance offered to the user during the interview process, according to various embodiments.

The selected interchangeable analytics module 113 receives the user data 116 from the tax return preparation engine 112, analyzes the user data 116, and generates the individualized interview content 117 based on the user data 116, according to one embodiment. The selected interchangeable analytics module 113 is an interchangeable component/module within the tax return preparation system 111, according to one embodiment. In other words, the selected interchangeable analytics module 113 can be modified, overwritten, deleted and/or conveniently replaced/updated with different and/or improved analytics modules, such as any of interchangeable analytics modules 152, 153, 154, and 155, of service provider support computing environment 150, without requiring modification to other components within the tax return preparation system 111, according to one embodiment. An advantage of implementing the selected interchangeable analytics module 113 as an interchangeable or pluggable module/component is that, while one version of the selected interchangeable analytics module 113 is being executed, improved versions, i.e., other analytics modules, such as the interchangeable analytics modules 152, 153, 154, and 155, of service provider support computing environment 150, can be developed and tested. One or more of the other interchangeable analytics modules 152, 153, 154, and 155 can then made available to the tax return preparation engine 112 without making changes to the tax return preparation engine 112, or other components within the tax return preparation system 111, according to one embodiment.

As a result of this interchangeable or pluggable capability associated with the selected interchangeable analytics module 113, the static and inflexible nature of currently available tax return preparation applications is replaced with efficient and dynamically modifiable tax return preparation application, thereby improving the technical fields of tax preparation, data analysis, and software application modification and update.

The selected interchangeable analytics module 113 is configured to receive and respond to commands, requests, instructions, and/or other communications from the tax return preparation engine 112 using an application programming interface (“API”), according to one embodiment. For example, the selected interchangeable analytics module 113 receives the user data 116 from the tax return preparation engine 112 through one or more API-based requests or commands from the tax return preparation engine 112, according to one embodiment. As another example, the selected interchangeable analytics module 113 transmits the individualized interview content 117 to the tax return preparation engine 112 using one or more API-based functions, routines, and/or calls, according to one embodiment.

The selected interchangeable analytics module 113 draws from the tax return preparation interview tools 114 to generate the individualized interview content 117, according to one embodiment. The selected interchangeable analytics module 113 can apply any one of a number of algorithms or analysis techniques to the user data 116 to generate analytic data 118, according to one embodiment. The analytic data 118 can represent the application of a predictive model, a collaborative filter, or other analytics to the user data 116, according to one embodiment. The selected interchangeable analytics module 113 determines, chooses, and/or individualizes the user's interview process by selecting tools from the tax return preparation interview tools 114, based at least partially on the analytic data 118 and/or the user data 116, according to one embodiment.

The tax return preparation interview tools 114 include, but are not limited to, a question pool 119, pictures 120, themes 121, user assistance 122, and profiles 123, according to one embodiment. The question pool 119 includes all of the questions that can be presented or that must be made available for the user during the tax return preparation interview, according to one embodiment. The question pool 119 groups the questions by topic, according to one embodiment. In the specific illustrative example of FIG. 1, the question pool 119 includes four groups of questions that are represented by topic A, topic B, topic C, and topic D, according to one embodiment. While the question pool 119 is represented as having four topics, it is to be understood that the interview questions can be categorized into many more or less topics, according to various embodiments. Examples of topics, by which the question pool 119 may be grouped, include, but are not limited to, one or more of: earned income credit, child tax credit, charitable contributions, cars and personal property, education, medical expenses, taxes paid, moving expenses, job expenses, residential energy credits, property taxes, mortgage interest, interest and dividend income, and the like. In some implementations, the question pool 119 is grouped by high-level topics such as home, self and family, charitable contributions, education, medical, and the like. In other implementations, the question pool 119 includes low-level topics that are subgroups of the high-level topics, and include, but are not limited to, mortgage interest credit, homebuyer credit, elderly/disabled credit, legal fees, student loan interest, scholarships, state and local tax refunds, and/or any other form of question or data acquisition, as discussed herein, and/or as known in the art at the time of filing, and/or as developed after the time of filing, according to various embodiments.

The pictures 120 and the themes 121 include variations for the graphical user interface user experience elements that can be used by the tax return preparation engine 112 to provide an individualized interview experience, and/or interface, to a user, according one embodiment. The pictures 120 include images of varying topics/themes, shapes, sizes, and colors that can be positioned proximate to questions or question topics to assist the user in understanding the gist of the series of questions being presented, according to one embodiment. For example, the pictures 120 can include a house, a doctor or stethoscope, children, a school, a car, and the like, according to one embodiment. The themes 121 include background colors, font colors, font sizes, animations, avatars, other theme-related graphics that can be applied to text or graphics within the user interface 115 while communicating with the user, and/or any other form of theme, as discussed herein, and/or as known in the art at the time of filing, and/or as developed after the time of filing, according to various embodiments.

The user assistance 122 includes various options for providing assistance to a user during the tax return preparation interview, according to one embodiment. Examples of the user assistance 122 include, but are not limited to, one or more of an instant message dialog box, an offer to call the user, a fax number, a mailing address, a phone number to which text messages may be transmitted, a URL or other link, an address to a tax return specialist that is local to the geographic location of the user, and/or any other form of user assistance, as discussed herein, and/or as known in the art at the time of filing, and/or as developed after the time of filing, according to various embodiments.

The profiles 123 represents a repository, data structure, or database of user data that is grouped based on commonalities between the user's and/or the users' data, according to one embodiment. The profiles 123 are grouped based on criteria such as marital status, approximate income range, job title, age ranges, homeownership status, employment status, zip code, level of education, and the like, according to one embodiment. Each profile of the profiles 123 can be associated with a particular set of user data variables. The particular set of user data variables can be associated with a particular sequence of topics in the question pool, with a particular theme, with a particular type of user assistance, and/or with one or more particular pictures, according to one embodiment. Accordingly, the production environment may associate a user with a particular one of the profiles 123 in order to indirectly assign the user to a particular sequence of topics in the question pool 119, according to one embodiment.

The selected interchangeable analytics module 113 uses one or more of the question pool 119, the pictures 120, the themes 121, the user assistance 122, and the profiles 123 to generate the individualized interview content 117, according one embodiment. The sequence of the topics might, by default, be presented in the order topic A, topic B, topic C, and topic D. However, based on the analytic data 118, the selected interchangeable analytics module 113 determines which of the topics A-D are more relevant to a user and determines which of the topics A-D are less relevant to the user, according to one embodiment. The selected interchangeable analytics module 113 then generates the individualized interview content 117 by creating a sequence of the topics A-D (and associated questions) that is more relevant to the user than the default sequence, according to one embodiment. In some embodiments, the selected interchangeable analytics module 113 may generate a sequence that is devoid of questions associated with one or more of the topics A-D. In another embodiment, the selected interchangeable analytics module 113 pushes the least relevant or apparently irrelevant questions to a single page at the end of the interview. For example, the selected interchangeable analytics module 113 can determine that, based on the user's age and income, topics B and C are highly relevant to the user and that topics A and D are likely to be a nuisance, i.e., highly irrelevant to the user. In such a case, the selected interchangeable analytics module 113 can cause the tax return preparation engine 112 to present topics B and C to the user first and present the irrelevant topics A and D for the user to optionally consider at the end of the interview. Additionally, the selected interchangeable analytics module 113 can cause the tax return preparation engine 112 to offer a reduced product price or to more quickly display some form of human resource assistance for the user based on a user's profile or based on the user data 116 to individualize the user's interview experience, according to one embodiment. Accordingly, the selected interchangeable analytics module 113 can create the individualized interview content 117 to prioritize or sequence the presentation of tax topics, and can otherwise individualize the interview content to suit the user's probable preferences, according to one embodiment.

According to one embodiment, the components within the tax return preparation system 111 communicate with the selected interchangeable analytics module 113 using API functions, routines, and/or calls. However, according to another embodiment, the selected interchangeable analytics module 113 and the tax return preparation engine 112 can use a common store 124 for sharing, communicating, or otherwise delivering information between different features or components within the tax return preparation system 111. The common store 124 includes, but is not limited to, the user data 116, the analytic data 118, and tax return preparation engine data 125, according to one embodiment. The selected interchangeable analytics module 113 can be configured to store information and retrieve information from the common store 124 independent of information retrieved from and stored to the common store 124 by the tax return preparation engine 112, according to one embodiment. In addition to the selected interchangeable analytics module 113 and the tax return preparation engine 112, other components within the tax return preparation system 111 and other computer environments may be granted access to the common store 124 to facilitate communications with the selected interchangeable analytics module 113 and/or the tax return preparation engine 112, according to one embodiment.

The tax return preparation engine 112 can be configured to synchronously or asynchronously retrieve, apply, and present the individualized interview content 117, according to various embodiments. For example, the tax return preparation engine 112 can be configured to wait to receive the individualized interview content 117 from the selected interchangeable analytics module 113 before continuing to query or communicate with a user regarding additional information or regarding topics from the question pool 119, according to one embodiment. The tax return preparation engine 112 can alternatively be configured to submit user data 116 to the selected interchangeable analytics module 113 or submit another request to the selected interchangeable analytics module 113 and concurrently continue functioning/operating without waiting for a response from the selected interchangeable analytics module 113, according to one embodiment. In other words, the tax return preparation engine 112 can be configured to asynchronously continue to operate independent of the selected interchangeable analytics module 113 even though the selected interchangeable analytics module 113 is processing information that is needed by the tax return preparation engine 112. The tax return preparation engine 112 then incorporates information from the selected interchangeable analytics module 113 as the selected interchangeable analytics module 113 makes the information available, according to one embodiment. In one embodiment, a few initial or preliminary questions are presented to the user prior to executing the selected interchangeable analytics module 113. In other embodiments, the tax return preparation engine 112 calls the analytics module at any time during the tax return preparation interview process.

In one embodiment, as discussed below, the selection of selected interchangeable analytics module 113 from, as an example, a pool of interchangeable analytics modules, such as interchangeable analytics modules 152, 153, 154, and 155, is made based, at least in part, on these few initial or preliminary questions presented to the user. In addition, as also discussed below, in one embodiment, the selection of selected interchangeable analytics module 113, and/or exchange of selected interchangeable analytics module 113 for another selected interchangeable analytics module from, as an example, a pool of interchangeable analytics modules, such as interchangeable analytics modules 152, 153, 154, and 155, is made based, at least in part, on any, or all, of user data 116, during any part of the user experience and interview process.

The interchangeability of interchangeable analytics module 113 represents a significant improvement over prior art architectures that included analytics hard-coded into the tax return preparation application which made it impractical to update the analytics, at least without also updating other components within the tax return preparation system. Various techniques can be used to incorporate the selected interchangeable analytics module 113 into the tax return preparation system 111, according to one embodiment. In another embodiment, the selected interchangeable analytics module 113 is interchangeably and/or pluggably integrated into the tax return preparation system 111 with an analytics module selection engine 126. The analytics module selection engine 126 can include a text-based or graphical-based user interface that enables a user to select an analytics module for insertion into the tax return preparation system 111, according to one embodiment.

Alternatively, the analytics module selection engine 126 can be configured to automatically and/or dynamically retrieve and implement an interchangeable analytics module into the tax return preparation system 111 based on information about the user, such as, but not limited to, user data 116, according to one embodiment. For example, the analytics module selection engine 126 can receive the user data 116 from the tax return preparation engine 112, according to one embodiment. The analytics module selection engine 126 can then use the user data 116 to retrieve prior user tax return data 151 from the service provider support computing environment 150. The analytics module selection engine 126 also provides the user data 116 to the public information computing environment 160 to facilitate a search of public records related to the user, according to one embodiment. The public information computing environment 160 represents various social media, search engines, web servers, and other Internet-based public record search tools, according to one embodiment. The public information computing environment 160 includes real estate values 161, social media 162, and financial history 163, according to one embodiment. When the analytics module selection engine 126 provides the user data 116 to the public information computing environment 160, the public information computing environment 160 can be configured to return a home value of the user or the average home value of the zip code of the user; life changes detected from social media searches, e.g., birth of a child or career change; the financial well-being, e.g., indebtedness, of the user, and/or various other data and metrics according to various embodiments.

The analytics module selection engine 126 is configured to use the prior user tax return data 151 along with the information acquired from the public information computing environment 160 to determine which one of a number of analytics modules to incorporate in the tax return preparation system 111, according to one embodiment. As illustrated, the service provider support computing environment 150 can include a number of different interchangeable analytics modules, for example, the interchangeable analytics module 152, the interchangeable analytics module 153, the interchangeable analytics module 154, and the interchangeable analytics module 155, according to one embodiment. Each of the interchangeable analytics modules 152-155 incorporate a different algorithm for generating the analytic data 118 and the individualized interview content 117 based on the user data 116, according to one embodiment. As discussed above, briefly, the interchangeable analytics modules 113, 152-155 can utilize a number analysis algorithms and techniques, such as predictive models and collaborative filters, according to various embodiments.

The analytics module selection engine 126 and/or the selected interchangeable analytics module 113 is configured to use the prior user tax return data 151 along with the information acquired from the public information computing environment 160 to sequence, prioritize, or otherwise order the topical questions presented to the user during the tax return preparation interview, according to one embodiment. For example, based on life-changes, such as job changes, marriage changes, phone number changes, and address changes (e.g., as detected in sites such as Facebook and LinkedIn), the analytics module selection engine 126 and/or the selected interchangeable analytics module 113 can cause the tax return preparation engine 112 to present questions to the user that are most likely to have changed from a previous year. Such questions may advantageously invoke feelings of trust and/or personal connection from the user towards the tax return preparation system 111. Consequently, in contrast to traditional tax preparation software programs, the user is provided with a personal, relatively brief, focused, and simple interview process, according to one embodiment. This, in turn, allows for relevant data collection using fewer processing cycles and less communications bandwidth. As a result, embodiments of the present disclosure allow for improved processor performance, more efficient use of memory access and data storage capabilities, reduced communication channel bandwidth utilization, and faster communications connections. Consequently, computing and communication systems implementing and/or providing the embodiments of the present disclosure are transformed into faster and more operationally efficient devices and systems.

The user data 116 can be used by the tax return preparation engine 112 and/or the selected interchangeable analytics module 113 to associate a user with a particular predetermined profile, e.g., with a set of criteria or with a group of users who share one or more characteristics in common with the user, according to one embodiment. However, in other embodiments, a user's answers to one or more initial interview questions can be used by the selected interchangeable analytics module 113 to identify peers of the user, e.g., other users who are preparing a tax return, or who have recently prepared a tax return, and who share similar user data characteristics. The selected interchangeable analytics module 113, or another component within the tax return preparation system 111, identify the topics that were commonly relevant to the peers of the user and can emphasize or prioritize the questions associated with those topics that were more relevant to the peers of the user, according to one embodiment. This up-to-date analysis can simplify the analysis of the user data 116 while improving the likelihood that the tax return preparation engine 112 will be able to accurately prioritize questions that are likely to be relevant to the user, based on the user's peers, according to one embodiment.

The foregoing discloses embodiments of a production environment 100 that enables a number of versions of an interchangeable analytics module to be incorporated into the tax return preparation system 111, for a single system. However, in some embodiments, the interchangeable and pluggable analytics modules 113, 152-155 can be integrated into other tax return preparation programs, using the API interface, the common store interface, or some other interface between the interchangeable analytics module and the other components of the other tax return preparation software, according to one embodiment.

According to one embodiment, the production environment 100 is configured to generate an alert, insert human resource assistance, and/or inject any other form of user assistance, into the interview when regulatory compliance issues arise. If the user enters or attempts to force inconsistent data into the tax return preparation system, the tax return preparation engine 112 may generate an alert for the user, for a tax professional, and/or for a system administrator, according to one embodiment. For example, if the user initially indicates that he/she does not have children, yet the user repeatedly attempts to force the system to apply a child tax credit, the production environment can be configured to generate one or more alerts or notifications to prevent the user from inconsistent or fraudulent activities, according to one embodiment.

As described above, the production environment 100 employs an architecture that supports one or more interchangeable, pluggable, and/or conveniently updatable interchangeable analytics modules for individualizing the tax return preparation interview for a user. Unlike traditional tax return preparation systems, the tax return preparation system 111 can reduce confusion, frustration, and trust issues of users by prioritizing the sequence of questions presented to the user so that more relevant questions are provided to the user and irrelevant questions are presented to the user in an optional, i.e., capable of being skipped, format, according to one embodiment. As a result, the features and techniques described herein are, in many ways, superior to the service received from a tax return specialist/preparer. For example, human error associated with a tax return specialist is eliminated, the hours of availability of the tax return specialist become irrelevant, the daily number of customers is not limited by the number of people a tax return specialist is able to visit within a daily basis, and the computerized tax return preparation process is unaffected by emotion, fatigue, stress, or other external factors that may be inherent in a tax return specialist during tax return season.

The various embodiments of the disclosure can be implemented to improve the technical fields of user experience, automated tax return preparation, data collection, and data processing. Therefore, the various described embodiments of the disclosure and their associated benefits amount to significantly more than an abstract idea. In particular, by individualizing or personalizing the tax return preparation interview, a tax return preparation application may be able to gather more complete information from the user and may be able to provide a more thorough and customized analysis of potential tax return benefits for the user, according to one embodiment. Furthermore, by employing an interchangeable, pluggable, and/or modular analytics module, new and/or improved versions of the interchangeable analytics module may be developed and incorporated into the tax return preparation application to improve the interview process without having to rewrite, and re-test other components within the tax return preparation application, according to one embodiment.

In addition, as noted above, by minimizing, or potentially eliminating, the processing and presentation of irrelevant questions to a user, implementation of embodiments of the present disclosure allows for significant improvement to the field of data collection and data processing. As one illustrative example, by minimizing, or potentially eliminating, the processing and presentation of irrelevant question data to a user, implementation of embodiments of the present disclosure allows for relevant data collection using fewer processing cycles and less communications bandwidth. As a result, embodiments of the present disclosure allow for improved processor performance, more efficient use of memory access and data storage capabilities, reduced communication channel bandwidth utilization, and faster communications connections. Consequently, computing and communication systems implementing and/or providing the embodiments of the present disclosure are transformed into faster and more operationally efficient devices and systems.

### Process

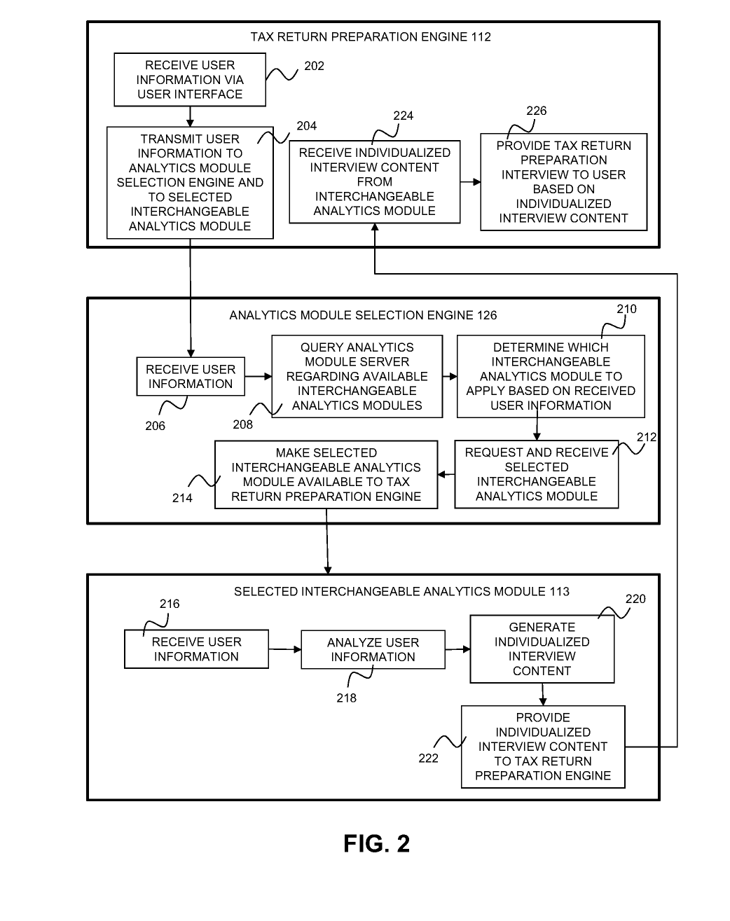

FIG. 2 illustrates a functional flow diagram of a process 200 for providing a tax return preparation system with the interchangeable analytics modules of the production environment 100, according to one embodiment. Although a particular sequence of events is described hereafter, more or less events may be included in the process 200, according to various embodiments.

At block 202, the tax return preparation engine 112 receives user information via a user interface, according to one embodiment.

At block 204, the tax return preparation engine 112 transmits the user information to an analytics module selection engine and to a selected interchangeable analytics module, according to one embodiment.

At block 206, the analytics module selection engine 126 receives the user information from the tax return preparation engine 112, according to one embodiment.

At block 208, the analytics module selection engine 126 queries an interchangeable analytics module server regarding available interchangeable analytics modules, according to one embodiment. The analytics module server may be one or more databases that are included within the service provider computing environment 110 or the database may be external to the service provider computing environment 110, according to various embodiments.

At block 210, the analytics module selection engine 126 determines which interchangeable analytics module to apply/select as the selected interchangeable analytics module based on the received user information, according to one embodiment.

At block 212, the analytics module selection engine 126 requests and receives a selected interchangeable analytics module, according to one embodiment.

At block 214, the analytics module selection engine 126 makes the selected interchangeable analytics module available to the tax return preparation engine 112, according to one embodiment. For example, the analytics module selection engine 126 can copy the selected interchangeable analytics module into a particular range of memory addresses within a computing environment that are used by the tax return preparation application/system to execute the selected interchangeable analytics module, according to one embodiment. The analytics module selection engine 126 can copy the selected interchangeable analytics module into a memory location that is accessible by the other components of the tax return preparation application, and the analytics module selection engine 126 can update a pointer table or other data structure used by the tax return preparation application so that calls, requests, and/or routines that rely upon the selected interchangeable analytics module may be properly directed to the newly installed selected interchangeable analytics module, according to one embodiment.

At block 216, the selected interchangeable analytics module 113 receives user information, according to one embodiment. The selected interchangeable analytics module 113 can receive the user information from the tax return preparation engine 112 or from the analytics module selection engine 126 after the selected interchangeable analytics module 113 has been installed, according to various embodiments.

At block 218, the selected interchangeable analytics module 113 analyzes the user information, according to one embodiment. As described above, various analysis algorithms such as predictive modeling or collaborative filtering may be applied to the user information, according to one embodiment.

At block 220, the selected interchangeable analytics module 113 generates individualized interview content, and/or other user experience features, according to one embodiment. The individualized interview content can include, but is not limited to, one or more of: a sequence with which interview questions are presented, the content/topics of the interview questions that are presented, the font sizes used while presenting information to the user, the length of descriptions provided to the user, themes presented during the interview process, the types of icons displayed to the user, the type of interface format presented to the user, images displayed to the user, assistance resources listed and/or recommended to the user, backgrounds presented, avatars presented to the user, highlighting mechanisms used and highlighted features, and any other features that individually, or in combination, create a user experience, as discussed herein, and/or as known in the art at the time of filing, and/or as developed after the time of filing.

The individualized interview content is compiled and/or generated based on the received user information and the analysis of the user information, according to one embodiment.

At block 222, the selected interchangeable analytics module 113 provides the individualized interview content to the tax return preparation engine 112 for use by and/or delivery to the user, according to one embodiment. The selected interchangeable analytics module 113 can be configured to communicate with the tax return preparation engine 112 using an API, a common data store, or other techniques, according to various embodiments.

At block 224, the tax return preparation engine 112 receives the individualized interview content from the selected interchangeable analytics module 113, according to one embodiment.

At block 226, the tax return preparation engine 112 provides the tax return preparation interview to the user based on the individualized interview content, according to one embodiment. The tax return preparation engine 112 can provide the tax return preparation interview to the user synchronously, i.e., only after certain information is received from the selected interchangeable analytics module 113, according to one embodiment. The tax return preparation engine 112 can provide the tax return preparation interview to the user asynchronously, i.e., concurrent with data analysis being performed by the selected interchangeable analytics module 113, according to one embodiment. In one embodiment, providing the tax return preparation interview to the user based on the individualized interview content transforms the user interface display from a default user interface into an individualized or customized user interface. In one embodiment, providing the tax return preparation interview to the user based on the individualized interview content transforms a default sequence of interview questions into a new and/or modified relevancy-ordered sequence of interview questions. This, in turn, allows for significant improvement to the technical fields of user experience, electronic tax return preparation, data collection, and data processing by using fewer processing cycles and less communications bandwidth. As a result, embodiments of the present disclosure allow for improved processor performance, more efficient use of memory access and data storage capabilities, reduced communication channel bandwidth utilization, and faster communications connections. Consequently, computing and communication systems implementing and/or providing the embodiments of the present disclosure are transformed into faster and more operationally efficient devices and systems.

Although a particular sequence is described herein for the execution of the process 200, other sequences can also be implemented, according to other embodiments.

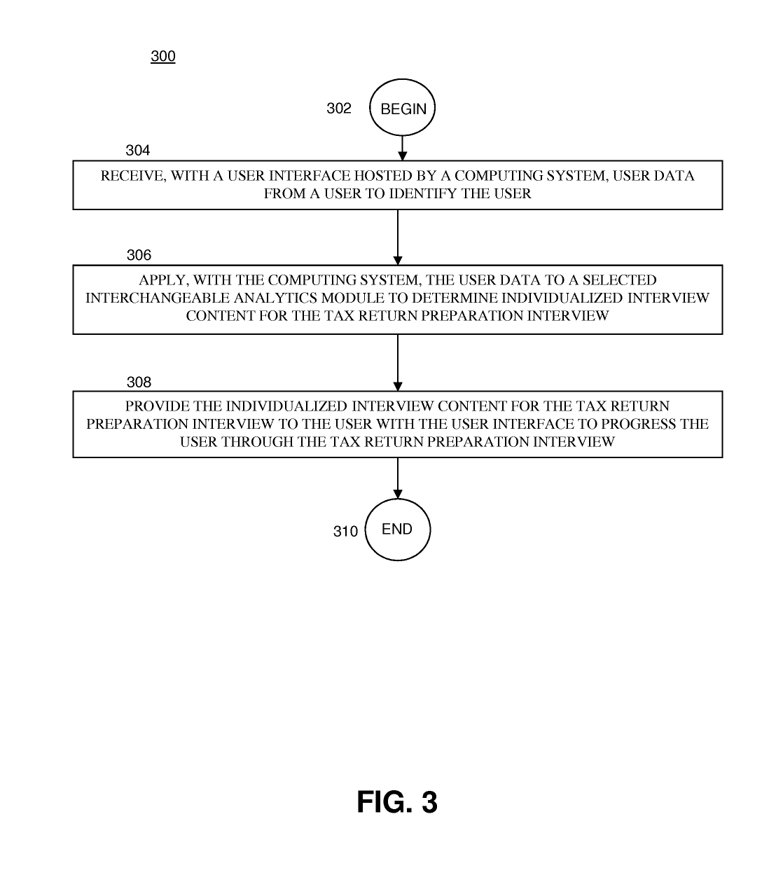

FIG. 3 illustrates a flow diagram of a process 300 for individualizing a tax return preparation experience for a user, using a tax return preparation system with interchangeable analytics modules of the production environment 100, according to various embodiments.

At block 302, the process begins.

At block 304, the process receives, with a user interface hosted by a computing system, user data from a user to identify the user, according to one embodiment. The user data includes one or more of a name, an address, a birth date, a government identification, a marital status, a home ownership status, a number of children, ages of the number of children, a job title, an annual income, an employment status, a previous tax return, and a level of completed education, according to one embodiment.

At block 306, the process applies, with the computing system, the user data to a selected interchangeable analytics module to determine individualized interview content for the tax return preparation interview, according to one embodiment. The interview content includes a plurality of questions related to multiple tax-related topics, and the questions are grouped by the multiple tax-related topics, according to one embodiment. The selected interchangeable analytics module determines a sequence of the plurality of questions by determining a level of relevancy to the user of each of the multiple tax-related topics, based at least partially on the user data, according to one embodiment.

At block 308, the process provides the individualized interview content for the tax return preparation interview to the user with the user interface to progress the user through the tax return preparation interview, according to one embodiment.

At block 310, the process ends.

As noted above, the specific illustrative examples discussed above are but illustrative examples of implementations of embodiments of the method or process for individualizing the tax return preparation interview with an interchangeable, e.g., modular, analytics module. Those of skill in the art will readily recognize that other implementations and embodiments are possible. Therefore the discussion above should not be construed as a limitation on the claims provided below.

In accordance with one embodiment, a computing system implemented method includes providing a tax return preparation system with one or more interchangeable analytics modules. The method includes providing the one or more interchangeable analytics modules, each of the one or more interchangeable analytics modules can include one or more analytics algorithms used by the interchangeable analytics module to select user experience elements for a tax return preparation interview process to be presented to a user through one or more tax return preparation systems, according to one embodiment. The method includes receiving, with a user interface hosted by a computing system, user data associated with a user, according to one embodiment. The method includes applying, with the computing system, the user data to a selected interchangeable analytics module of the one or more interchangeable analytics modules, according to one embodiment. The method includes processing the user data, using the selected interchangeable analytics module of the one or more interchangeable analytics modules to select the user experience elements for the tax return preparation interview process to be provided to the user through with the one or more tax return preparation systems, according to one embodiment. The method includes using the selected user experience elements to transform the tax return preparation interview process associated with the one or more tax return preparation systems into a personalized tax return preparation interview process that is personalized to the user, according to one embodiment.

In accordance with one embodiment, a system provides one or more tax return preparation systems with interchangeable analytics modules. The system includes one or more tax return preparation systems; and a set of one or more user experience elements for a tax return preparation interview process to be presented to a user through the one or more tax return preparation systems, according to one embodiment. The system includes one or more interchangeable analytics modules, and each of the one or more interchangeable analytics modules can include one or more analytics algorithms used by the interchangeable analytics module to select user experience elements for the tax return preparation interview process to be presented to a user through the one or more tax return preparation systems, according to one embodiment. The system includes a user interface hosted by a computing system, and the user interface can receive user data associated with a user, according to one embodiment. The system includes one or more processors, according to one embodiment. The system includes a computer-readable medium having a plurality of computer-executable instructions which, when executed by the one or more processors, perform a method for providing a tax return preparation system with interchangeable analytics modules, according to one embodiment. The method of the system includes applying, with a computing system, the user data to a selected interchangeable analytics module of the one or more interchangeable analytics modules, according to one embodiment. The method of the system includes processing the user data, using the selected interchangeable analytics module of the one or more interchangeable analytics modules to select user experience elements for the tax return preparation interview process to be provided to the user through the one or more tax return preparation systems, according to one embodiment. The method of the system includes using the selected user experience elements to transform the tax return preparation interview process associated with the one or more tax return preparation systems into a personalized tax return preparation interview process personalized to the user, according to one embodiment.

According to one embodiment, a computer-readable medium includes a plurality of computer-executable instructions which, when executed by a processor, perform a method for providing a tax return preparation system with interchangeable analytics modules. The instructions include a tax return preparation engine that hosts a user interface to receive user data from a user and to provide interview content to the user to progress the user through the tax return preparation interview process, according to one embodiment. The instructions include a selected interchangeable analytics module of one or more interchangeable analytics modules that applies one or more algorithms to the user data to generate the interview content at least partially based on the user data, according to one embodiment. The selected interchangeable analytics module retrieves at least part of the interview content from a data store, and the interview content includes a plurality of questions, according to one embodiment. The questions are grouped by multiple tax-related topics, and the selected interchangeable analytics module determines a sequence of delivery of the plurality of questions for the tax return preparation engine, according to one embodiment. The sequence of delivery is at least partially based on a relevance of each of the multiple tax-related topics to the user and at least partially based on the user data, according to one embodiment. The instructions include an analytics module selection engine that enables interchangeability between the selected interchangeable analytics module and others of the one or more interchangeable analytics modules, according to one embodiment. The analytics module selection engine selectively overwrites the selected interchangeable analytics module with another of the one or more interchangeable analytics modules at least partially based on the user data, according to one embodiment.

In accordance with one embodiment, a method and system for individualizing a tax return preparation interview includes receiving, with a user interface hosted by a computing system, user data from a user to identify and categorize the user. The user data includes one or more of a name, an address, a birth date, a government identification, a marital status, a home ownership status, a number of children, ages of the number of children, a job title, an annual income, an employment status, a previous tax return, and a level of completed education, according to one embodiment. The method and system includes applying, with the computing system, the user data to a selected one of one or more interchangeable analytics modules to determine interview content for the tax return preparation interview, according to one embodiment. The interview content includes a plurality of questions related to multiple tax-related topics, and the questions are grouped by the multiple tax-related topics, according to one embodiment. The selected one of one or more interchangeable analytics modules determines a sequence of the plurality of questions by determining a level of relevancy to the user of each of the multiple tax-related topics, based at least partially on the user data, according to one embodiment. The method and system include providing the interview content for the tax return preparation interview to the user with the user interface in an order customized to the user to progress the user through the tax return preparation interview, according to one embodiment.

In accordance with one embodiment, a computer-readable medium includes a plurality of computer-executable instructions for individualizing a tax return preparation interview. The instructions include a tax return preparation engine that hosts a user interface to receive user data from a user and to provide interview content to the user to progress the user through the tax return preparation interview, according to one embodiment. The user data includes one or more of a name, an address, a birth date, a government identification, a marital status, a home ownership status, a number of children, ages of the number of children, a job title, an annual income, an employment status, and a level of completed education, according to one embodiment. The instructions include a selected one of one or more interchangeable analytics modules that applies one or more algorithms to the user data to generate the interview content at least partially based on the user data, according to one embodiment. The selected one of one or more interchangeable analytics modules retrieves at least part of the interview content from a data store, and the interview content includes a plurality of questions, according to one embodiment. The questions are grouped by multiple tax-related topics, and the selected one of one or more interchangeable analytics modules determines a sequence of delivery of the plurality of questions for the tax return preparation engine, according to one embodiment. The sequence of delivery is at least partially based on a relevance of each tax-related topic to the user and at least partially based on the user data, according to one embodiment. The instructions include an analytics module selection engine that enables interchangeability between the selected interchangeable analytics module and other interchangeable analytics modules, and the analytics module selection engine selectively overwrites the selected interchangeable analytics module with one or more of the other interchangeable analytics modules at least partially based on the user data, according to one embodiment.

By minimizing, or potentially eliminating, the processing and presentation of irrelevant questions and/or other user experience elements to a user, implementation of embodiments of the present disclosure allows for significant improvement to the technical fields of user experience, electronic tax return preparation, data collection, and data processing. As one illustrative example, by minimizing, or potentially eliminating, the processing and presentation of irrelevant question data to a user, implementation of embodiments of the present disclosure uses fewer human resources (e.g., time, focus) by not asking irrelevant questions and allows for relevant data collection by using fewer processing cycles and less communications bandwidth. As a result, embodiments of the present disclosure allow for improved processor performance, more efficient use of memory access and data storage capabilities, reduced communication channel bandwidth utilization, faster communications connections, and improved user efficiency. Consequently, computing and communication systems are transformed into faster and more operationally efficient devices and systems by implementing and/or providing the embodiments of the present disclosure. Therefore, implementation of embodiments of the present disclosure amount to significantly more than an abstract idea and also provide several improvements to multiple technical fields.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

As discussed in more detail above, using the above embodiments, with little or no modification and/or input, there is considerable flexibility, adaptability, and opportunity for customization to meet the specific needs of various users under numerous circumstances.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as, but not limited to, “activating,” “accessing,” “adding,” “aggregating,” “alerting,” “applying,” “analyzing,” “associating,” “calculating,” “capturing,” “categorizing,” “classifying,” “comparing,” “creating,” “defining,” “detecting,” “determining,” “distributing,” “eliminating,” “encrypting,” “extracting,” “filtering,” “forwarding,” “generating,” “identifying,” “implementing,” “informing,” “monitoring,” “obtaining,” “posting,” “processing,” “providing,” “receiving,” “requesting,” “saving,” “sending,” “storing,” “substituting,” “transferring,” “transforming,” “transmitting,” “using,” etc., refer to the action and process of a computing system or similar electronic device that manipulates and operates on data represented as physical (electronic) quantities within the computing system memories, resisters, caches or other information storage, transmission or display devices.

The present invention also relates to an apparatus or system for performing the operations described herein. This apparatus or system may be specifically constructed for the required purposes, or the apparatus or system can comprise a general purpose system selectively activated or configured/reconfigured by a computer program stored on a computer program product as discussed herein that can be accessed by a computing system or other device.

The present invention is well suited to a wide variety of computer network systems operating over numerous topologies. Within this field, the configuration and management of large networks comprise storage devices and computers that are communicatively coupled to similar or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIG.s, or as discussed herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A computing system implemented method for providing a tax return preparation system with one or more interchangeable analytics modules, comprising:
providing the one or more interchangeable analytics modules, each of the one or more interchangeable analytics modules including one or more analytics algorithms used by the interchangeable analytics module to select user experience elements for a tax return preparation interview process to be presented to a user through one or more tax return preparation systems;
receiving, with a user interface hosted by a computing system, user data associated with a user;
applying, with the computing system, the user data to a selected interchangeable analytics module of the one or more interchangeable analytics modules;
processing the user data, using the selected interchangeable analytics module of the one or more interchangeable analytics modules to select the user experience elements for the tax return preparation interview process to be provided to the user through with the one or more tax return preparation systems; and
using the selected user experience elements to transform the tax return preparation interview process associated with the one or more tax return preparation systems into a personalized tax return preparation interview process that is personalized to the user.

2. The method of claim 1, wherein at least part of the user data is selected from the group of user data consisting of:
data indicating the user's name;
data indicating the user's Social Security Number;
data indicating the user's government identification;
data indicating the user's a driver's license number;
data indicating the user's date of birth;
data indicating the user's address;
data indicating the user's zip code;
data indicating the user's home ownership status;
data indicating the user's marital status;
data indicating the user's annual income;
data indicating the user's job title;
data indicating the user's employer's address;
data indicating the user's spousal information;
data indicating the user's children's information;
data indicating the user's assets;
data indicating the user's medical history; and
data indicating the user's occupation.

3. The method of claim 1, wherein the user experience elements include at least one user experience element selected from the group of user experience elements consisting of:
a sequence with which interview questions are presented to the user during the personalized tax return preparation interview process;
content or topics of the interview questions that are presented to the user during the personalized tax return preparation interview process;
font sizes used while presenting information to the user during the personalized tax return preparation interview process;
length of descriptions provided to the user during the personalized tax return preparation interview process;
themes presented to the user during the personalized tax return preparation interview process;
types of icons displayed to the user during the personalized tax return preparation interview process;
types of interface formats presented to the user during the personalized tax return preparation interview process;
images displayed to the user during the personalized tax return preparation interview process;
assistance resources listed and/or recommended to the user during the personalized tax return preparation interview process;
backgrounds presented to the user during the personalized tax return preparation interview process;
avatars presented to the user during the personalized tax return preparation interview process;
highlighting mechanisms used and highlighted features presented to the user during the personalized tax return preparation interview process.

4. The method of claim 3, wherein the types of assistance resources listed and/or recommended to the user during the personalized tax return preparation interview process include one or more assistance resources selected from the group of assistance resources consisting of:
a telephone call;
electronic text messaging;
instant messaging; and
a professional tax return specialist that are local to a geographic location of the user.

5. The method of claim 1, wherein providing the user experience elements for the personalized tax return preparation interview process includes synchronously providing the user experience elements by waiting for a completion of one or more computations by the selected interchangeable analytics module of the one of the one or more interchangeable analytics modules prior to providing at least part of the user experience elements to the user.

6. The method of claim 1, wherein providing the user experience elements for the personalized tax return preparation interview process includes asynchronously providing the user experience elements concurrently with a processing of one or more computations by the selected interchangeable analytics module of the one of the one or more interchangeable analytics modules.

7. The method of claim 1, wherein the one of the one or more interchangeable analytics modules include an application programming interface through which the one of the one or more interchangeable analytics modules receives and transmits communications.

8. The method of claim 1, wherein the selected interchangeable analytics module of the one of the one or more interchangeable analytics modules transmits and receives information using a common store,
wherein the common store receives, stores, and delivers communications for inter-component communications within a computer-readable tax return preparation instruction set.

9. The method of claim 1, further comprising:
generating an alert if the user data fails to comply with one or more tax regulations.

10. The method of claim 1, wherein the selected interchangeable analytics module is selected from the one or more interchangeable analytics modules based, at least in part, on at least a portion of the user data at any point in the tax return preparation interview process.

11. The method of claim 1, wherein the selected interchangeable analytics module is one independent component of multiple components in a computer-readable tax return preparation instruction set,
wherein the selected interchangeable analytics module is a first interchangeable analytics module and is interchangeable with a second interchangeable analytics module without changing others of the multiple components in the computer-readable tax return preparation instruction set.

12. The method of claim 11, wherein the first interchangeable analytics module is interchanged with the second interchangeable analytics module at any point in the tax return preparation interview process.

13. The method of claim 1, wherein the selected interchangeable analytics module of the one or more interchangeable analytics modules associates the user with one of a plurality of taxpayer profiles,
wherein each of the plurality of taxpayer profiles includes multiple data representing users having common characteristics,
wherein each of the plurality of taxpayer profiles is associated with a predetermined sequence of the plurality of questions.

14. The method of claim 1, wherein the user data is first user data, the method further comprising:
retrieving second user data at least partially based on the first user data,
wherein the second user data includes at least one previous year's tax return for the user; and
determining the user experience elements of the personalized tax return preparation interview process based at least partially on the second user data.

15. The method of claim 1, wherein the selected interchangeable analytics module determines a sequence of a plurality of questions included in the user experience elements of the personalized tax return preparation interview process by determining a level of relevancy to the user of each of multiple tax-related topics based at least partially on one or more of an annual salary, an age, a zip code, a job title, an address, a telephone number, a number of children, and a marital status of the user.

16. The method of claim 1, further comprising:
searching social media servers based at least partially on the user data to determine whether one or more life-style changes has occurred for the user,
wherein the one or more life-style changes includes a job change, an address change, a telephone number change, a marital status change, and a number of children change,
wherein the selected interchangeable analytics module determines a sequence of the plurality of questions included in the user experience elements of the personalized tax return preparation interview process at least partially based on whether the one or more life-style changes has occurred for the user.

17. The method of claim 1, further comprising:
hosting two or more interchangeable analytics modules; and
replacing the selected interchangeable analytics module with another of the two or more analytics modules, based at least in part on the user data.

18. A system for providing one or more tax return preparation systems with interchangeable analytics modules comprising:
one or more tax return preparation systems;
a set of one or more user experience elements for a tax return preparation interview process to be presented to a user through the one or more tax return preparation systems;
one or more interchangeable analytics modules, each of the one or more interchangeable analytics modules including one or more analytics algorithms used by the interchangeable analytics module to select user experience elements for the tax return preparation interview process to be presented to a user through the one or more tax return preparation systems;
a user interface hosted by a computing system, the user interface receiving user data associated with a user;
one or more processors;
a computer-readable medium having a plurality of computer-executable instructions which, when executed by the one or more processors, perform a method for providing a tax return preparation system with interchangeable analytics modules, the method comprising:
applying, with a computing system, the user data to a selected interchangeable analytics module of the one or more interchangeable analytics modules;
processing the user data, using the selected interchangeable analytics module of the one or more interchangeable analytics modules to select user experience elements for the tax return preparation interview process to be provided to the user through the one or more tax return preparation systems; and
using the selected user experience elements to transform the tax return preparation interview process associated with the one or more tax return preparation systems into a personalized tax return preparation interview process personalized to the user.

19. The system of claim 18, wherein at least part of the user data is selected from the group of user data consisting of:
data indicating the user's name;
data indicating the user's Social Security Number;
data indicating the user's government identification;
data indicating the user's a driver's license number;
data indicating the user's date of birth;
data indicating the user's address;
data indicating the user's zip code;
data indicating the user's home ownership status;
data indicating the user's marital status;
data indicating the user's annual income;
data indicating the user's job title;
data indicating the user's employer's address;
data indicating the user's spousal information;
data indicating the user's children's information;
data indicating the user's assets;
data indicating the user's medical history; and
data indicating the user's occupation.

20. The system of claim 18, wherein the user experience elements include at least one user experience element selected from the group of user experience elements consisting of:
a sequence with which interview questions are presented to the user during the personalized tax return preparation interview process;
content/topics of the interview questions that are presented to the user during the personalized tax return preparation interview process;
font sizes used while presenting information to the user during the personalized tax return preparation interview process;
length of descriptions provided to the user during the personalized tax return preparation interview process;
themes presented to the user during the during the personalized tax return preparation interview process;
types of icons displayed to the user during the personalized tax return preparation interview process;
types of interface formats presented to the user during the personalized tax return preparation interview process;
images displayed to the user during the personalized tax return preparation interview process;
assistance resources listed and/or recommended to the user during the personalized tax return preparation interview process;
backgrounds presented to the user during the personalized tax return preparation interview process;
avatars presented to the user during the personalized tax return preparation interview process; and
highlighting mechanisms used and highlighted features presented to the user during the personalized tax return preparation interview process.

21. The system of claim 20, wherein the types of assistance resources listed and/or recommended to the user during the personalized tax return preparation interview process include one or more assistance resources selected from the group of assistance resources consisting of:
a telephone call;
electronic text messaging;
instant messaging; and
a professional tax return specialist that are local to a geographic location of the user.

22. The system of claim 18, wherein the method further includes synchronously providing the user experience elements for the personalized tax return preparation interview process by waiting for a completion of one or more computations by the selected interchangeable analytics module of the one or more interchangeable analytics modules prior to providing at least part of the user experience elements to the user.

23. The system of claim 18, wherein the method further includes asynchronously providing the user experience elements for the personalized tax return preparation interview process by providing the user experience elements concurrently with a processing of one or more computations by the selected interchangeable analytics module of the one of the one or more interchangeable analytics modules.

24. The system of claim 18, wherein the one of the one or more interchangeable analytics modules includes an application programming interface through which the one of the one or more interchangeable analytics modules receives and transmits communications.

25. The system of claim 18, wherein the selected interchangeable analytics module of the one of the one or more interchangeable analytics modules transmits and receives information using a common store,
wherein the common store receives, stores, and delivers communications for inter-component communications within a computer-readable tax return preparation instruction set.

26. The system of claim 18, wherein the method further comprises:
generating an alert if the user data fails to comply with one or more tax regulations.

27. The system of claim 18, wherein the selected interchangeable analytics module is selected from the one or more interchangeable analytics modules based, at least in part, on at least a portion of the user data at any point in the tax return preparation interview process.

28. The system of claim 18, wherein the selected interchangeable analytics module is one independent component of multiple components in a computer-readable tax return preparation instruction set,
wherein the selected interchangeable analytics module is a first interchangeable analytics module and is interchangeable with a second interchangeable analytics module without changing others of the multiple components in the computer-readable tax return preparation instruction set.

29. The system of claim 28, wherein the first interchangeable analytics module is interchanged with the second interchangeable analytics module at any point in the tax return preparation interview process.

30. The system of claim 18, wherein the selected interchangeable analytics module of the one or more interchangeable analytics modules associates the user with one of a plurality of taxpayer profiles,
wherein each of the plurality of taxpayer profiles includes multiple data representing users having common characteristics,
wherein each of the plurality of taxpayer profiles is associated with a predetermined sequence of the plurality of questions.

31. The system of claim 18, wherein the user data is first user data, the method further comprising:
retrieving second user data at least partially based on the first user data,
wherein the second user data includes at least one previous year's tax return for the user; and
determining the user experience elements of the personalized tax return preparation interview process based at least partially on the second user data.

32. The system of claim 18, wherein the selected interchangeable analytics module determines a sequence of a plurality of questions included in the user experience elements of the personalized tax return preparation interview process by determining a level of relevancy to the user of each of multiple tax-related topics based at least partially on one or more of an annual salary, an age, a zip code, a job title, an address, a telephone number, a number of children, and a marital status of the user.

33. The system of claim 18, wherein the method further comprises:
searching social media servers based at least partially on the user data to determine whether one or more life-style changes has occurred for the user,
wherein the one or more life-style changes includes a job change, an address change, a telephone number change, a marital status change, and a number of children change,
wherein the selected interchangeable analytics module determines a sequence of the plurality of questions included in the user experience elements of the personalized tax return preparation interview process at least partially based on whether the one or more life-style changes has occurred for the user.

34. The system of claim 18, wherein the method further comprises:
hosting two or more interchangeable analytics modules; and
replacing the selected interchangeable analytics module with another of the two or more analytics modules, based at least in part on the user data.

35. A computer-readable medium having a plurality of computer-executable instructions which, when executed by a processor, perform a method for providing a tax return preparation system with interchangeable analytics modules, the instructions comprising:
a tax return preparation engine that hosts a user interface to receive user data from a user and to provide interview content to the user to progress the user through the tax return preparation interview process;
a selected interchangeable analytics module of one or more interchangeable analytics modules that applies one or more algorithms to the user data to generate the interview content at least partially based on the user data,
wherein the selected interchangeable analytics module retrieves at least part of the interview content from a data store,
wherein the interview content includes a plurality of questions,
wherein the questions are grouped by multiple tax-related topics,
wherein the selected interchangeable analytics module determines a sequence of delivery of the plurality of questions for the tax return preparation engine,
wherein the sequence of delivery is at least partially based on a relevance of each of the multiple tax-related topics to the user and at least partially based on the user data; and
an analytics module selection engine that enables interchangeability between the selected interchangeable analytics module and others of the one or more interchangeable analytics modules,
wherein the analytics module selection engine selectively overwrites the selected interchangeable analytics module with another of the one or more interchangeable analytics modules at least partially based on the user data.

36. The computer-readable medium of claim 35, wherein at least part of the user data is selected from the group of user data consisting of:
data indicating the user's name;
data indicating the user's Social Security Number;
data indicating the user's government identification;
data indicating the user's a driver's license number;
data indicating the user's date of birth;
data indicating the user's address;
data indicating the user's zip code;
data indicating the user's home ownership status;
data indicating the user's marital status;
data indicating the user's annual income;
data indicating the user's job title;
data indicating the user's employer's address;
data indicating the user's spousal information;
data indicating the user's children's information;
data indicating the user's assets;
data indicating the user's medical history; and
data indicating the user's occupation.

37. The computer-readable medium of claim 35, wherein the instructions further comprise:
a common store that receives data from the tax return preparation engine and from the selected interchangeable analytics module,
wherein the common store provides the data to the tax return preparation engine and to the selected interchangeable analytics module to enable communications between the tax return preparation engine and the selected interchangeable analytics module.

38. The computer-readable medium of claim 35, wherein the tax return preparation engine is configured to request the interview content from the selected interchangeable analytics module during any one of a number of stages within the tax return preparation interview process for the user.

39. The computer-readable medium of claim 35, wherein the user data is first user data,
wherein the selected interchangeable analytics module and/or the analytics module selection engine retrieves second user data at least partially based on the first user data,
wherein the second user data includes at least one previous year's tax return for the user,
wherein the selected interchangeable analytics module determines the sequence of delivery of the plurality of questions for the tax return preparation engine at least partially based on the first user data and the second user data.

40. The computer-readable medium of claim 35, wherein the interview content further includes one or more pictures, images, themes, and types of user assistance.

41. The computer-readable medium of claim 40, wherein the types of user assistance include one or more of a telephone call, electronic text messaging, instant messaging, and a professional tax return specialist that are local to a geographic location of the user.

42. The computer-readable medium of claim 35, wherein the selected interchangeable analytics module includes an application programming interface through which the selected interchangeable analytics module communicates with the tax return preparation engine.

43. The computer-readable medium of claim 35, wherein the selected interchangeable analytics module selection engine selectively overwrites the selected interchangeable analytics module, in response to a command from a system administrator.

44. The computer-readable medium of claim 35, wherein the selected interchangeable analytics module selection engine selectively overwrites the selected interchangeable analytics module automatically, at least partially based on the user data, a prior year's tax return for the user, and publically available electronic information about the user.

45. The computer-readable medium of claim 35, wherein the relevance of the multiple tax-related topics include higher levels of relevance and lower levels of relevance,
wherein providing the interview content for the tax return preparation interview process includes providing the questions associated with the lower levels of relevance near an end of the tax return preparation interview process.

46. The computer-readable medium of claim 35, wherein the relevance of the multiple tax-related topics include higher levels of relevance and lower levels of relevance,
wherein providing the interview content for the tax return preparation interview process includes providing the questions associated with the lower levels of relevance after the questions associated with the higher levels of relevance.

47. A computing system implemented method for providing a tax return preparation system with one or more interchangeable analytics modules, comprising:
providing the one or more interchangeable analytics modules, each of the one or more interchangeable analytics modules including one or more analytics algorithms used by the interchangeable analytics module to select user experience elements for a tax return preparation interview process to be presented to a user through one or more tax return preparation systems;
receiving, with a user interface hosted by a computing system, user data associated with a user;
applying, with the computing system, the user data to a selected interchangeable analytics module of the one or more interchangeable analytics modules;
processing the user data, using the selected interchangeable analytics module of the one or more interchangeable analytics modules to select the user experience elements for the tax return preparation interview process to be provided to the user through with the one or more tax return preparation systems; and
using the selected user experience elements to generate a tax preparation interview process associated with the one or more tax return preparation systems.

48. The method of claim 47, wherein the user experience elements include at least one user experience element selected from the group of user experience elements consisting of:
a sequence with which interview questions are presented to the user during the personalized tax return preparation interview process;
content or topics of the interview questions that are presented to the user during the personalized tax return preparation interview process;
font sizes used while presenting information to the user during the personalized tax return preparation interview process;
length of descriptions provided to the user during the personalized tax return preparation interview process;
themes presented to the user during the personalized tax return preparation interview process;
types of icons displayed to the user during the personalized tax return preparation interview process;
types of interface formats presented to the user during the personalized tax return preparation interview process;
images displayed to the user during the personalized tax return preparation interview process;
assistance resources listed and/or recommended to the user during the personalized tax return preparation interview process;
backgrounds presented to the user during the personalized tax return preparation interview process;
avatars presented to the user during the personalized tax return preparation interview process;
highlighting mechanisms used and highlighted features presented to the user during the personalized tax return preparation interview process.

49. The method of claim 47, wherein the one of the one or more interchangeable analytics modules include an application programming interface through which the one of the one or more interchangeable analytics modules receives and transmits communications.

50. The method of claim 47, wherein the selected interchangeable analytics module of the one of the one or more interchangeable analytics modules transmits and receives information using a common store,
wherein the common store receives, stores, and delivers communications for inter-component communications within a computer-readable tax return preparation instruction set.

51. The method of claim 47, wherein the selected interchangeable analytics module is selected from the one or more interchangeable analytics modules based, at least in part, on at least a portion of the user data at any point in the tax return preparation interview process.

52. The method of claim 47, wherein the selected interchangeable analytics module is one independent component of multiple components in a computer-readable tax return preparation instruction set,
wherein the selected interchangeable analytics module is a first interchangeable analytics module and is interchangeable with a second interchangeable analytics module without changing others of the multiple components in the computer-readable tax return preparation instruction set.

53. The method of claim 52, wherein the first interchangeable analytics module is interchanged with the second interchangeable analytics module at any point in the tax return preparation interview process.
